(19) United States
(12) Patent Application Publication
(10) Pub. No.: US 2006/0215327 A1
(43) Pub. Date: Sep. 28, 2006

(54) Magnetic head with a slider and a gimbal suspension structured flexure having outriggers

(75) Inventor: Michiharu Motonishi, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/388,619

(22) Filed: Mar. 23, 2006

(30) Foreign Application Priority Data
Mar. 25, 2005 (JP) 2005-088958

(51) Int. Cl. G11B 5/48

(52) U.S. Cl. 360/245.3

(57) ABSTRACT

A magnetic head may include a flexure coupled to a leading end of a load beam. The flexure may include a fixing portion fixed to the load beam, a pair of outriggers extending from opposite ends of the fixing portion toward the leading end of the load beam, a connector connecting the outriggers, a blade spring extending from a center of the connector toward the fixing portion in a space between the outriggers, and a tongue-shaped piece connected to and supported by the blade spring and having a slider on its surface facing a recording medium. The flexure may further include one or more slits. Thus, the tongue-shaped piece may be displaceably supported against elastic stress of portions of the blade spring and the connector.

This application claims priority to Japanese Application No. 2005-088958, which was filed on Mar. 25, 2005 and is incorporated herein by reference.

### TECHNICAL FIELD

The present invention relates to a magnetic head equipped in a hard disk drive or the like.

### BACKGROUND

A magnetic head typically includes a load beam that extends over a rotating hard disk (i.e., a recording medium) and oscillates. The load beam is coupled with a flexure having a tongue-shaped piece which is fixed to a slider and is resiliently displaceable.

Further, the load beam is provided with an oscillation projection which contacts the tongue-shaped piece of the flexure and forms an oscillation fulcrum of the slider. The tongue-shaped piece is connected to the flexure by a blade spring which extends from a leading end of the flexure in an axial direction of the load beam. As the blade spring is resiliently deformed, the slider is displaced to trace irregularities on a recording surface of the hard disk. Magnetic heads of this type are described in Japanese Unexamined Patent Application Publications Nos. 2002-150734, 2001-043647, 2002-170351, and 09-128920, for example.

According to a contact start stop (CSS) type magnetic head, when a hard disk is stopped, a surface of the slider opposite to the hard disk comes into contact with an inner circumferential surface of the hard disk. Then, when the hard disk starts to rotate, airflow is generated between the slider and the surface of the hard disk along a rotation direction of the hard disk. Due to the airflow streaming between the surface of the hard disk and the surface of the slider opposite to the hard disk, and to a lifting force generated by viscosity of the air, the slider floats from the surface of the hard disk. The oscillation projection serves as the oscillation fulcrum for displacing the slider (i.e., the tongue-shaped piece of the flexure) to trace the minute irregularities on the recording surface of the hard disk. Thus, the slider performs oscillating movements (e.g., pitching, rolling, and yawing) due to resilience of the blade spring connected to the tongue-shaped piece. Such magnetic heads are described in Japanese Unexamined Patent Application Publications Nos. 2002-150734, 2001-043647, 2002-170351, and 09-128920, for example.

In hard disks of recent years, the volume of the slider and the area of a surface of the slider opposite to the hard disk, e.g., an ABS (acrylonitrile butadiene styrene) surface, has been reduced, along with an increase in recording density. Further, the distance between the slider and the surface of the hard disk has been reduced down to approximately 10 nm, and thus the magnitude of the displacement obtained while the slider operates to trace the irregularities on the recording surface of the hard disk has been also reduced.

According to a typical flexure, therefore, elastic stress (i.e., a spring constant) of the blade spring connected to the tongue-shaped piece is so large that a tracing characteristic of the slider is degraded. However, if the blade spring supporting the tongue-shaped piece is exclusively adjusted, as in a case in which the length of the blade spring is increased to reduce the elastic stress of the blade spring, for example, the size of the magnetic head is increased. Further, if the thickness or width of the blade spring is reduced, sufficient elastic stress for separating the slider from the surface of the hard disk or a ramp may not be obtained at the start of a hard disk according to the CSS method or at the loading of the hard disk according to a ramp loading method. Furthermore, appropriate elastic stress may not be concurrently obtained in a pitching direction, a rolling direction, and a yawing direction of the slider. Moreover, variations in the elastic stress among magnetic heads may increase due to such factors as manufacturing error.

### SUMMARY

A magnetic head that may separate a slider from a recording medium or a ramp at the start or loading of the recording medium, and may improve the tracing characteristic of the slider in operation, is described herein.

The magnetic head includes an oscillatable load beam, a flexure, and a slider. The load beam has a leading end extending to a space over the recording medium. The flexure is coupled to the leading end of the load beam. The flexure includes a fixing portion fixed to the load beam and an attachment portion extending from the fixing portion. The flexure also includes at least one slit disposed in the attachment portion. The slit may divide the attachment portion into a plurality of portions elastically supporting a displacing part including a slider.

Therefore, when the slider is displaced to trace the minute irregularities on the recording medium, the slider may be displaced by the elastic twisting stress in addition to the elastic bending stress from the attachment portion. Therefore, the trace displacement characteristic of the slider may be improved. Further, at the start of the recording medium, according to the CSS method, or at the loading of the recording medium, according to the ramp loading method, if the load beam moves to displace the slider by more than the amount of trace displacement of the slider, the elastic bending stress and the elastic twisting stress may increase. Accordingly, the slider may be reliably separated from the ramp or the surface of the recording medium.

### BRIEF DESCRIPTION OF THE DRAWINGS

FIG. 1 is an exploded perspective view of related parts of a magnetic head according to one embodiment.

FIG. 2 is a plan view of the related parts of the magnetic head according to the embodiment of FIG. 1.

FIG. 3 is a side view of the related parts of the magnetic head according to the embodiment of FIG. 1.

FIG. 4 is a plan view of slits formed on a flexure of the magnetic head illustrated in FIG. 1, according to a first embodiment, as viewed from a load beam side.

FIG. 5 is a plan view of slits formed on the flexure of the magnetic head illustrated in FIG. 1, according to a second embodiment, as viewed from the load beam side.

FIG. 6 is a plan view of slits formed on the flexure of the magnetic head illustrated in FIG. 1, according to a third embodiment, as viewed from the load beam side.

FIG. 7 is a plan view of slits formed on the flexure of the magnetic head illustrated in FIG. 1, according to a fourth embodiment, as viewed from the load beam side.

### DETAILED DESCRIPTION

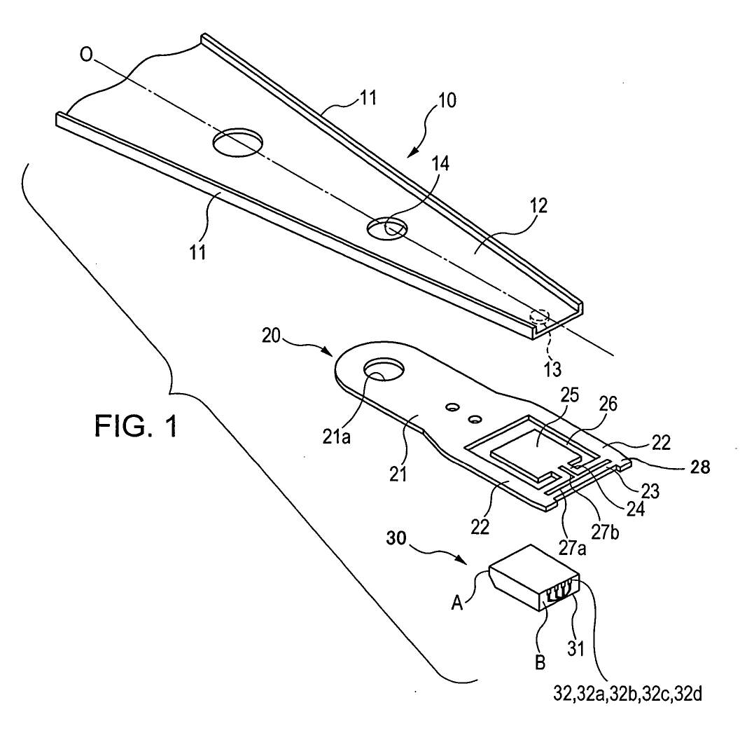

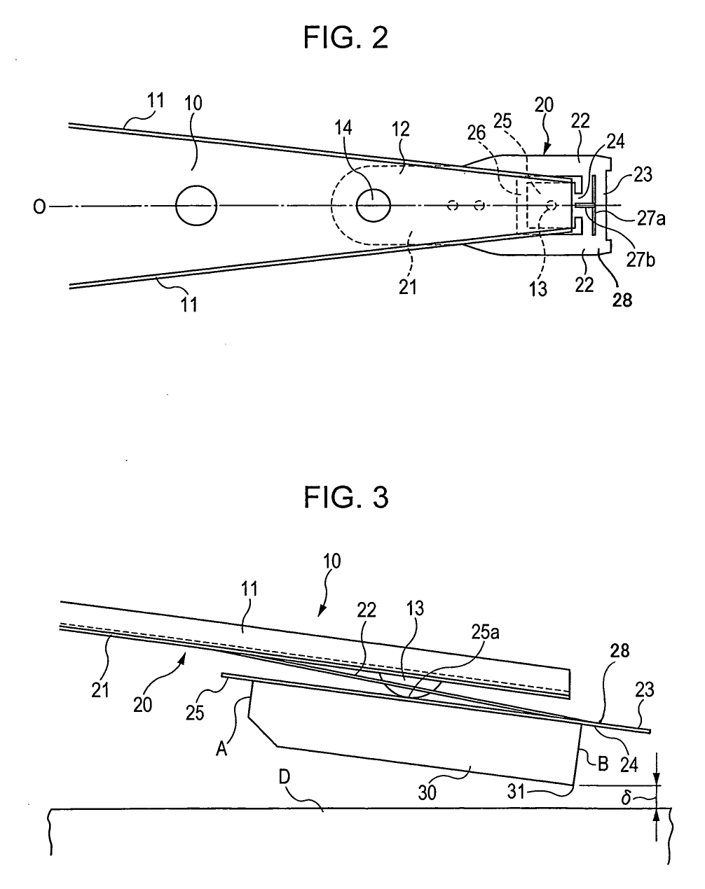

As illustrated in FIGS. 1 to 3, a magnetic head according to one embodiment has a flexure 20 supporting a slider 30 with respect to a load beam 10. The slider 30 may be fixed to a displacing part or tongue-shaped piece 25 of the flexure 20 such that the slider 30 faces a recording disk (i.e., a recording medium) D (see FIG. 3), such as a hard disk. The slider 30 may be made of a material such as a ceramic. On a trailing surface B of the slider 30, a thin film element 31 may be formed. The thin film element 31 may include a GMR (giant magnetoresistive) head (i.e., a reading head) and an inductive head (i.e., a writing head). The GMR head may detect a leakage magnetic field from the recording disk D by using a magnetoresistive effect and may read magnetic signals. The inductive head may include a patterned coil. Further, on the trailing surface B of the slider 30, four electrodes 32 (e.g., electrodes 32a to 32d), which are connected to the GMR head and the inductive head of the thin film element 31, may be provided.

The load beam 10 includes an oscillating shaft (not illustrated) positioned away from the recording disk D which is driven to rotate. A leading end of the load beam 10 extends to a space over the recording disk D, and may be coupled to the flexure 20. The load beam 10 and the flexure 20 may both be made of a material used for forming a blade spring (e.g., a metallic material such as, for example, stainless steel). On opposite sides of the load beam 10, folds 11 may be formed to extend from the leading end of the load beam 10 to longitudinally intermediate positions of the load beam 10 for increasing the stiffness of the load beam 10. The folds 11 flank a flat portion 12 having a projecting contact portion (i.e., a hemispheric projection) 13. The projecting contact portion 13 may be positioned near a leading end of the flat portion 12 and protrude from a surface of the flat portion 12 toward the recording disk D (i.e., in a downward direction in FIG. 3).

The flexure 20 may include a fixing portion 21 and an attachment portion 28. The attachment portion 28 may include a pair of outriggers 22, a connector 23, and a blade spring 24. The outriggers 22 may extend parallel to each other from opposite sides of a leading end of the fixing portion 21. The connector 23 may connect leading ends of the outriggers 22. The blade spring 24 may extend from a center of a rear edge of the connector 23 into a space defined by inner edges of the fixing portion 21, the pair of outriggers 22, and the connector 23.

The tongue-shaped piece 25 may be supported by the attachment portion 28. According to one embodiment, the tongue-shaped piece 25 may be connected to a leading end of the blade spring 24. That is, the tongue-shaped piece 25 may be separated from the fixing portion 21, the pair of outriggers 22, and the connector 23 by a generally U-shaped groove 26 formed between the tongue-shaped piece 25 and the inner edges of the fixing portion 21, the pair of outriggers 22, and the connector 23. Further, the tongue-shaped piece 25 may be displaced to oscillate due to elasticity of the blade spring 24. The slider 30 may be bonded and fixed to a surface of the tongue-shaped piece 25 opposite to the recording disk D, with a spacer projection or the like being placed between the tongue-shaped piece 25 and the recording disk D.

The fixing portion 21 of the flexure 20 may have a positioning hole 21a, and the flat portion 12 of the load beam 10 may have a positioning hole 14. Upon alignment of the positioning holes 21a and 14 with each other, the fixing portion 21 may be fixed to a surface of the load beam 10 opposite to the recording disk D. The fixing portion 21 may be fixed to the surface of the load beam 10 by using, for example, a welding device, such as a spot welding device. In this fixing process, an oscillation point 25a of the tongue-shaped piece 25, which is positioned at an approximate center between the opposite sides of the load beam 10, abuts the projecting contact portion (i.e., the hemispheric projection) 13 formed on the load beam 10. Thereby, a slider 30 which is bonded and fixed to the surface of the tongue-shaped piece 25 opposite to the recording disk D may freely change its posture against elastic stress of the blade spring 24 and the connector 23, with the apex of the projecting contact portion 13 serving as a supporting point. That is, the slider 30 can perform displacement movements (e.g., pitching and rolling) to accurately trace irregularities on the recording disk D. The load beam 10 has elastic force for contacting the slider 30 to the recording disk D.

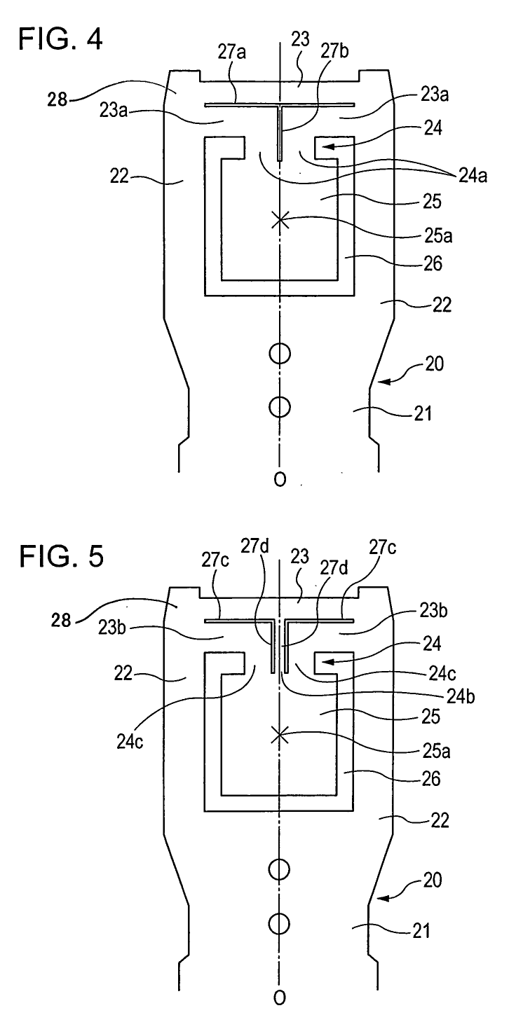

The flexure 20 may include at least one slit. The slit may pass partially or fully through a thickness of the flexure. The slit may be disposed in the attachment portion. According to a first embodiment, the flexure 20 may include a horizontal slit 27a and a vertical slit 27b. The slits may be formed in a T-shape on the connector 23 and the blade spring 24. FIG. 4 is an enlarged view of the flexure 20 according to the first embodiment. The horizontal slit 27a may extend on the connector 23 in a direction perpendicular to a longitudinal line O piercing through a rotation center of the load beam 10 coupled to the fixing portion 21. The vertical slit 27b may extend on the blade spring 24 along the longitudinal line O in contact with the horizontal slit 27a. That is, the vertical slit 27b may divide the blade spring 24 into a pair of blade spring portions 24a. Further, the horizontal slit 27a and the vertical slit 27b may form a pair of L-shaped portions, each including the blade spring portion 24a and the connector portion 23a. The tongue-shaped piece 25 may be displaceably supported by the elasticity of the blade spring portions 24a and the connector portions 23a. According to the first embodiment, each of opposite ends of the horizontal slit 27a may extend to a side edge of its corresponding outrigger 22, i.e., to a position on an extended line of an inner edge of the outrigger 22. Furthermore, one end of the vertical slit 27b may extend to a position on a boundary between the blade spring 24 and the tongue-shaped piece 25.

The outriggers 22, the connector 23, the blade spring 24, and the tongue-shaped piece 25 may be formed by etching out the generally U-shaped groove 26 which defines them. The horizontal slit 27a and the vertical slit 27b also may be formed by etching.

A conductive pattern (not illustrated) may be formed by a thin film and the like on a surface of the flexure 20 opposite to the load beam 10. In a leading end region of the flexure 20, the conductive pattern may extend from the pair of outriggers 22 to the connector 23 and the tongue-shaped piece 25. The tongue-shaped piece 25 may be provided with electrodes bonded to the thin-film electrodes 32a to 32d drawn from the thin-film element 31.

When the flexure 20 according to the first embodiment is connected to the load beam 10, the oscillation point 25a of the tongue-shaped piece 25 may be pressed against the projecting contact portion (i.e., hemispheric projection) 13 mainly by the elastic twisting stress and elastic bending stress of the connector portions 23a, which are portions of the connector 23 at the side of the blade spring 24 divided by the horizontal slit 27a, and by elastic bending stress of the blade spring portions 24a. As a result, the tongue-shaped piece 25 may be held so as to protrude from a plane including the generally U-shaped groove 26 toward the recording disk D (see FIG. 3).

FIG. 3 illustrates the slider 30 in a floating state (i.e., in a state in which the recording disk D is rotating). In this floating posture, the slider 30 is tilted such that a reading surface A of the slider 30 is lifted from the recording disk D higher than the trailing surface B of the slider 30. Thus, the slider 30 may float from the recording disk D by a distance delta. In this floating posture of the slider 30, the GMR head of the thin-film element 31 may detect a magnetic signal from the recording disk D, or the inductive head may write a magnetic signal on the recording disk D. Further, in the floating posture, the slider 30 may oscillate around the oscillation point 25a in contact with the projecting contact portion (i.e., hemispheric projection) 13. Thereby, the slider 30 may be displaced to accurately trace the irregularities on the recording surface of the recording disk D.

When the slider 30 operating in the floating state receives force for drawing the trailing surface B close to and away from the recording disk D, i.e., pitching force, the slider 30 may pitche against combined stresses from the elastic twisting stress and the elastic bending stress of the connector portions 23a and the blade spring portions 24a. Further, when the slider 30 receives rolling force, the slider 30 may roll against the elastic bending stress and the elastic twisting stress of the connector portions 23a and the blade spring portions 24a. According to the first embodiment, the posture of the slider 30 may be controlled by the above combined stresses from the elastic bending stress and the elastic twisting stress. In the flexure 20 according to the first embodiment, therefore, bending stiffness and twisting stiffness of the flexure 20 may be reduced by the horizontal slit 27a and the vertical slit 27b more than in a typical flexure. Accordingly, the slider 30 may be displaced to accurately trace the minute irregularities on the recording disk D. Further, when the slider 30 receives force displacing the slider 30 by an amount exceeding a displacement amount of the slider 30 caused while the slider 30 traces the irregularities on the recording disk D, the combined stresses may rapidly increase. That is, when the slider 30 is started by the CSS method or loaded by the ramp loading method, large elastic stresses may be generated between the slider 30 and the load beam 10. Accordingly, the slider 30 may follow movements of the load beam 10 and be started and loaded.

FIG. 5 illustrates slit patterns according to a second embodiment. The flexure 20 according to the second embodiment may have a pair of horizontal slits 27c and a pair of vertical slits 27d. The two horizontal slits 27c may extend through the connector 23 from respective positions near the blade spring 24 in opposite horizontal directions to each other. In addition, each of the vertical slits 27d may extend through the blade spring 24 from one end of its corresponding horizontal slit 27c toward the tongue-shaped piece 25. Further, the two vertical slits 27d may extend parallel to the longitudinal line O, while maintaining a predetermined distance between each other. Thus, the horizontal slits 27c and the vertical slits 27d may form a pair of approximately L-shaped slits. One end of each horizontal slit 27c at a side of its corresponding outrigger 22 may extend to one end of the connector 23 at the side of the outrigger 22, i.e., to a position near an extended line of the inner edge of the outrigger 22. In addition, one end of each vertical slit 27d at a side of the tongue-shaped piece 25 may extend to a position near the boundary between the blade spring 24 and the tongue-shaped piece 25.

A blade spring center portion 24b may be flanked by the pair of vertical slits 27d, while blade spring outside portions 24c may be positioned at outer sides of the respective vertical slits 27d. Connector portions 23b may be positioned at a side of the tongue-shaped piece 25 from the respective horizontal slits 27c. The tongue-shaped piece 25 is elastically supported by the blade spring center portion 24b, the blade spring outside portions 24c, and the connector portions 23b. With the oscillation point 25a serving as a supporting point, the tongue-shaped piece 25 is supported so it may oscillate in all directions by elastic bending stress and elastic twisting stress of the blade spring center portion 24b, the blade spring outside portions 24c, and the connector portions 23b.

According to the second embodiment, when the slider 30 receives force working in a pitching direction, the slider 30 may pitch mainly against combined stresses from elastic bending stress of the blade spring center portion 24b and elastic twisting stress and elastic bending stress of the connector portions 23b and the blade spring outside portions 24c. When the slider 30 receives the rolling force, the slider 30 may pitch mainly against combined stresses from elastic twisting stress of the blade spring center portion 24b and elastic bending stress and elastic twisting stress of the connector portions 23b and the blade spring outside portions 24c. In this way, according to the second embodiment, the posture of the slider 30 may be controlled by the above combined stresses from the elastic bending stress and the elastic twisting stress. Accordingly, the slider 30 may be displaced to accurately trace the minute irregularities on the recording disk D. Further, when the slider 30 is started by the CSS method or loaded by the ramp loading method, a large elastic stress may be generated between the slider 30 and the load beam 10. Accordingly, the slider 30 may follow the movements of the load beam 10 and may be reliably started and loaded.

FIG. 6 illustrates slit patterns according to a third embodiment. The flexure 20 according to the third embodiment has a horizontal slit 27e and vertical slits 27f. The horizontal slit 27e may horizontally extend through the connector 23, and pierce through the opposite ends of the connector 23 at the sides of the outriggers. 22 to extend into the outriggers 22. The vertical slits 27f may extend through the outriggers 22 from opposite ends of the horizontal slit 27e parallel to the longitudinal line O. Thus, the vertical slits 27f may be connected to the horizontal slit 27e. Each of the vertical slits 27f may extend through an approximate center of its corresponding outrigger 22 to a position on an extended line of the boundary between the blade spring 24 and the tongue-shaped piece 25.

The horizontal slit 27e may divide the connector 23 to form a connector portion 23c, while the vertical slits 27f may divide the outriggers 22 to form outrigger portions 22a. The tongue-shaped piece 25 may be supported by the connector portion 23c, the outrigger portions 22a, and the blade spring 24. With the oscillation point 25a serving as the supporting point, the tongue-shaped piece 25 is supported so it may oscillate in all directions by elastic bending stress and elastic twisting stress of the connector portion 23c, the outrigger portions 22a, and the blade spring 24.

According to the third embodiment, when the slider 30 receives the force working in the pitching direction, the slider 30 may roll mainly against combined stresses from the elastic bending stress of the outrigger portions 22a, elastic twisting stress of the connector portion 23c, and elastic bending stress of the blade spring 24. When the slider 30 receives the rolling force, the slider 30 may pitch mainly against combined stresses from elastic twisting stress of the outrigger portions 22a, elastic bending stress of the connector portion 23c, and elastic twisting stress of the blade spring 24. In this way, according to the third embodiment, the posture of the slider 30 may be controlled by the above combined stresses from the elastic bending stress and the elastic twisting stress. In the flexure 20 according to the third embodiment, therefore, the bending stiffness and the twisting stiffness of the flexure 20 may be reduced by the horizontal slit 27e and the vertical slits 27f more than in a typical flexure. Accordingly, the slider 30 may be displaced to accurately trace the minute irregularities on the recording disk D. Further, when the slider 30 is started by the CSS method or loaded by the ramp loading method, a large elastic stress may be generated between the slider 30 and the load beam 10. Accordingly, the slider 30 may follow the movements of the load beam 10 and be reliably started and loaded.

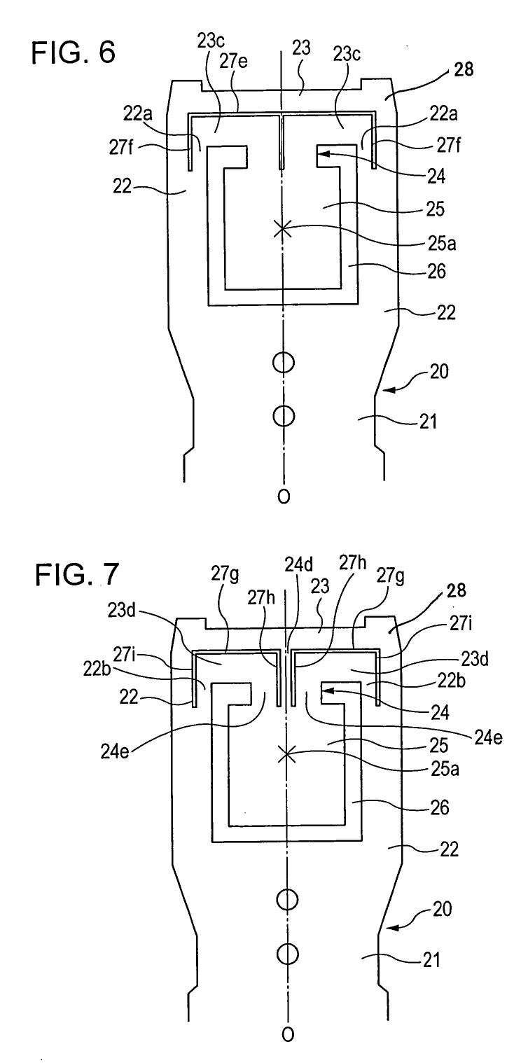

FIG. 7 illustrates slit patterns according to a fourth embodiment. The flexure 20 according to the fourth embodiment has a pair of horizontal slits 27g, a pair of vertical slits 27h, and a pair of vertical slits 27i. The two horizontal slits 27g may extend from respective positions on the connector 23 near the blade spring 24 in opposite horizontal directions to each other. Further, the horizontal slits 27g may pierce through the opposite ends of the connector 23 at the sides of the outriggers 22 to extend into the outriggers 22. The vertical slits 27h may extend through the blade spring 24 from one end of each of the horizontal slits 27g near the center of the connector 23 toward the tongue-shaped piece 25. Further, the vertical slits 27h may extend parallel to the longitudinal line O, while maintaining a predetermined distance between each other. Each of the vertical slits 27i may extend approximately parallel to the longitudinal line O, through the center of its corresponding outrigger 22 from one end of its corresponding horizontal slit 27g. Thus, the horizontal slits 27g, the vertical slits 27h, and the vertical slits 27i may form a pair of generally U-shaped slits. One end of each of the vertical slits 27h and one end of each of the vertical slits 27i at the side of the tongue-shaped piece 25 may extend to positions on the extended line of the boundary between the blade spring 24 and the tongue-shaped piece 25.

The horizontal slits 27g, the vertical slits 27h, and the vertical slits 27i may divide the connector 23, the blade spring 24, and the outriggers 22 to form a blade spring center portion 24d flanked by the vertical slits 27h, blade spring outside portions 24e, connector portions 23d, and outrigger portions 22b. The blade spring outside portions 24e, the connector portions 23d, and the outrigger portions 22b define the generally U-shaped groove 26. The tongue-shaped piece 25 is elastically supported by the blade spring center portion 24d, the blade spring outside portions 24e, the connector portions 23d, and the outrigger portions 22b. With the oscillation point 25a serving as the supporting point, the tongue-shaped piece 25 is supported so it may oscillate in all directions by elastic bending stress and elastic twisting stress of the blade spring center portion 24d, the blade spring outside portions 24e, the connector portions 23d, and the outrigger portions 22b.

According to the fourth embodiment, when the slider 30 in operation receives the force working in the pitching direction, the slider 30 may pitch against combined stresses from elastic bending stress of the blade spring center portion 24d, elastic bending stress of the connector portions 23d and elastic bending stress and elastic twisting stress of the blade spring outside portions 24e, the connector portions 23d, and the outrigger portions 22b. When the slider 30 receives the rolling force, the slider 30 may roll against combined stresses from elastic twisting stress of the blade spring center portion 24d and elastic bending stress and elastic twisting stress of the blade spring outside portions 24e, the connector portions 23d, and the outrigger portions 22b. In this way, according to the fourth embodiment, the posture of the slider 30 is controlled by the above combined stresses from the elastic bending stress and the elastic twisting stress. In the flexure 20 according to the fourth embodiment, therefore, the bending stiffness and the twisting stiffness of the flexure 20 may be reduced by the horizontal slits 27g, the vertical slits 27h, and the vertical slits 27i more than in a typical flexure. Accordingly, the slider 30 may be displaced to accurately trace the minute irregularities on the recording disk D. Further, when the slider 30 is started by the CSS method or loaded by the ramp loading method, large elastic stress may be generated between the slider 30 and the load beam 10. Accordingly, the slider 30 may follow the movements of the load beam 10 and may be reliably started and loaded.

As described above, according to the first to fourth embodiments, the posture of the slider 30 may be controlled by the combined stresses from the elastic bending stress and the elastic twisting stress. Therefore, the bending stiffness and twisting stiffness of the flexure 20 can be reduced by the slits more than in a typical flexure. Accordingly, appropriate elastic stresses may be applied in all oscillating directions, with the oscillation point serving as the supporting point. As a result, the tracing characteristic of the slider 30 may be improved. Further, an oscillation characteristic of the tongue-shaped piece 25 may be easily changed or adjusted by arranging the pattern and shape of the slits, without changing such factors as material, shape, and thickness of the flexure 20.

In the first to fourth embodiments, the outriggers 22, the connector 23, the blade spring 24, and the tongue-shaped piece 25 may be formed by etching out the generally U-shaped groove 26 which defines the outriggers 22, the connector 23, the blade spring 24, and the tongue-shaped piece 25. The slits 27a to 27i also may be formed by etching.

In terms of the width, length, and position of the vertical slits and the horizontal slits, embodiments of the present invention are not limited to the first to fourth embodiments illustrated in the drawings. For example, the vertical slits and the horizontal slits may be broader or narrower in width than the vertical slits and the horizontal slits of the above illustrated embodiments. Further, the length of the vertical slits and the horizontal slits may be determined according to combined stresses required in each case. Furthermore, the force working on the slider 30 during rotation of the recording disk D may vary between an inner radius position and an outer radius position of the recording disk D. Therefore, the width, length, and position of the vertical slits and the horizontal slits may not be symmetrical with respect to the longitudinal line O of the load beam 10.

Both the contact start stop (CSS) method and the ramp loading method can be applied to the magnetic heads according to the embodiments of the present invention.

What is claimed is:

1. A magnetic head comprising:
a flexure coupled to a leading end of an oscillatable load beam, the leading end extending to a space above a recording medium, the flexure comprising:
a fixing portion fixed to the load beam;
an attachment portion extending from the fixing portion, the attachment portion comprising:
a pair of outriggers extending from opposite ends of the fixing portion toward the leading end of the load beam;
a connector connecting leading ends of the pair of outriggers; and
a blade spring extending, in a space flanked by the pair of outriggers, from a center portion of the connector toward the fixing portion;
a displacing part elastically displaceable and connected to a leading end of the blade spring;
a slider fixed to a surface of the displacing part opposite to the recording medium; and,
at least one slit, the slit dividing the attachment portion into a plurality of portions elastically supporting the displacing part.

2. The magnetic head according to claim 1, wherein the at least one slit is disposed on at least one of the blade spring, the connector, and the pair of outriggers.

3. The magnetic head according to claim 1, wherein the at least one slit comprises:
a first slit disposed on the connector; and
a second slit disposed on the blade spring and the connector, the second slit being in contact with the first slit.

4. The magnetic head according to claim 3, wherein the second slit extends in a longitudinal direction of the load beam.

5. The magnetic head according to claim 1,
wherein the at least one slit comprises:
a pair of second slits disposed on the blade spring and the connector; and
a pair of first slits disposed on the connector, each of the first slits in contact with an end of one of the second slits.

6. The magnetic head according to claim 5, wherein the second slits extend parallel to each other in a longitudinal direction of the load beam.

7. The magnetic head according to claim 5, wherein the first slits extend to boundaries between the connector and the respective outriggers.

8. The magnetic head according to claim 1,
wherein the at least one slit comprises:
a first slit disposed on the connector; and
a pair of second slits disposed on the respective outriggers.

9. The magnetic head according to claim 8, wherein the first slit extends to approximate centers of the respective outriggers.

10. The magnetic head according to claim 8, wherein the pair of second slits extend from opposite ends of the first slit toward the fixing portion.

11. The magnetic head according to claim 8, further comprising a third slit extending from an approximate center of the first slit toward the fixing portion.

12. The magnetic head according to claim 1,
wherein the at least one slit comprises:
a pair of first slits disposed on the connector;
a pair of second slits disposed on the blade spring and the connector; and
a pair of third slits disposed on the respective outriggers.

13. The magnetic head according to claim 12, wherein each of the first slits extend on the connector from an end of one of the second slits to approximate centers of the respective outriggers.

14. The magnetic head according to claim 12, wherein the second slits are parallel to each other and extend toward the fixing portion.

15. The magnetic head according to claim 12, wherein the third slits extend from opposite ends of the first slits toward the fixing portion.

16. The magnetic head according to claim 3, wherein the second slit extends to a boundary between the blade spring and the displacing part.

17. The magnetic head according to claim 5, wherein each of the second slits extends to a boundary between the blade spring and the displacing part.

18. The magnetic head according to claim 8, wherein each of the second slits extends to a position on an extended line of a boundary between the blade spring and the displacing part.

19. The magnetic head according to claim 12, wherein each of the second slits extends to a boundary between the blade spring and the displacing part.

20. The magnetic head according to claim 12, wherein each of the third slits formed on the respective outriggers extends to a position on an extended line of a boundary between the blade spring and the displacing part.

21. The magnetic head according to claim 1, wherein the at least one slit passes through the thickness of the flexure.

22. The magnetic head according to claim 1, wherein either one of the displacing part and the load beam has a projecting contact portion projecting therefrom, the contact portion comprising a contact point, and the other one of the displacing part and the load beam has a contact surface contacting the projecting contact portion at the contact point such that the slider is displaced with the contact point serving as a displacement supporting point.

23. A magnetic head, comprising:
a flexure coupled to a leading end of an oscillatable load beam, the leading end extending to a space above a recording medium, the flexure comprising:
a fixing portion fixed to the load beam;
an attachment portion extending from the fixing portion;
at least one slit disposed in the attachment portion, the slit dividing the attachment portion into a plurality of portions elastically supporting a displacing part including a slider.

25. The magnetic head according to claim 23, wherein the at least one slit comprises:
a first slit nonparallel with a second slit.

26. The magnetic head according to claim 25, wherein the second slit is in contact with the first slit.

27. The magnetic head according to claim 25, wherein the second slit extends in a longitudinal direction of the load beam from an approximate center of the first slit.

28. The magnetic head according to claim 23, wherein the at least one slit comprises:
a pair of first slits nonparallel with a pair of second slits.

29. The magnetic head according to claim 28, wherein each of the first slits is in contact with one of the second slits.

30. The magnetic head according to claim 28, wherein each of the second slits extends from an end of one of the first slits in a longitudinal direction of the load beam.

31. The magnetic head according to claim 23, wherein the at least one slit comprises:
a first slit nonparallel with a pair of second slits.

32. The magnetic head according to claim 31, wherein the first slit is in contact with each of the second slits.

33. The magnetic head according to claim 31, wherein the second slits extend from opposite ends of the first slit in a longitudinal direction of the load beam.

34. The magnetic head according to claim 31, further comprising a third slit nonparallel with the first slit.

35. The magnetic head according to claim 34, wherein the third slit is in contact with the first slit.

36. The magnetic head according to claim 34, wherein the third slit extends from an approximate center of the first slit in a longitudinal direction of the load beam.

37. The magnetic head according to claim 23, wherein the at least one slit comprises:
a pair of first slits nonparallel with a pair of second slits and a pair of third slits.

38. The magnetic head according to claim 37, wherein each of the first slits is in contact with one of the second slits and one of the third slits.

39. The magnetic head according to claim 37, wherein each of the second slits and each of the third slits extend in a longitudinal direction of the load beam from an end of one of the first slits.
